(19) United States
(12) Patent Application Publication
(10) Pub. No.: US 2013/0016789 A1
(43) Pub. Date: Jan. 17, 2013

(54) CONTEXT MODELING TECHNIQUES FOR TRANSFORM COEFFICIENT LEVEL CODING

(71) Applicants: Jian Lou, San Diego, CA (US); Jae Hoon Kim, Santa Clara, CA (US); Limin Wang, San Diego, CA (US)

(72) Inventors: Jian Lou, San Diego, CA (US); Jae Hoon Kim, Santa Clara, CA (US); Limin Wang, San Diego, CA (US)

(73) Assignee: GENERAL INSTRUMENT CORPORATION, Horsham, PA (US)

(21) Appl. No.: 13/550,493

(22) Filed: Jul. 16, 2012

Related U.S. Application Data
(60) Provisional application No. 61/508,595, filed on Jul. 15, 2011.
(60) Provisional application No. 61/557,299, filed on Nov. 8, 2011.

(51) Int. Cl. H04N 7/30

(52) U.S. Cl. 375/240.18; 375/E07.226

(57) ABSTRACT

In one embodiment, a method for encoding video data is provided that includes receiving a transform unit comprising a two-dimensional array of transform coefficients and processing the transform coefficients of the two-dimensional array along a single-level scan order. The processing includes selecting, for each non-zero transform coefficient along the single-level scan order, one or more context models for encoding an absolute level of the non-zero transform coefficient, where the selecting is based on one or more transform coefficients previously encoded along the single-level scan order.

### CROSS-REFERENCES TO RELATED APPLICATIONS

The present application claims the benefit and priority under 35 U.S.C. 119(e) of U.S. Provisional Application No. 61/508,595, filed Jul. 15, 2011, entitled “CONTEXT MODELING FOR LEVEL CODING IN CABAC,” and U.S. Provisional Application No. 61/557,299, filed Nov. 8, 2011, entitled “WAVEFRONT SCAN AND RELATED CONTEXT MODELING.” The entire contents of these applications are incorporated herein by reference for all purposes.

### BACKGROUND

Video compression (i.e., coding) systems generally employ block processing for most compression operations. A block is a group of neighboring pixels and is considered a “coding unit” for purposes of compression. Theoretically, a larger coding unit size is preferred to take advantage of correlation among immediate neighboring pixels. Certain video coding standards, such as Motion Picture Expert Group (MPEG)-1, MPEG-2, and MPEG-4, use a coding unit size of 4×4, 8×8, or 16×16 pixels (known as a macroblock).

High efficiency video coding (HEVC) is an alternative video coding standard that also employs block processing. As shown in FIG. 1, HEVC partitions an input picture 100 into square blocks referred to as largest coding units (LCUs). Each LCU can be as large as 128×128 pixels, and can be partitioned into smaller square blocks referred to as coding units (CUs). For example, an LCU can be split into four CUs, each being a quarter of the size of the LCU. A CU can be further split into four smaller CUs, each being a quarter of the size of the original CU. This partitioning process can be repeated until certain criteria are met. FIG. 2 illustrates an LCU 200 that is partitioned into seven CUs (202-1, 202-2, 202-3, 202-4, 202-5, 202-6, and 202-7). As shown, CUs 202-1, 202-2, and 202-3 are each a quarter of the size of LCU 200. Further, the upper right quadrant of LCU 200 is split into four CUs 202-4, 202-5, 202-6, and 202-7, which are each a quarter of the size of quadrant.

Each CU includes one or more prediction units (PUs). FIG. 3 illustrates an example CU partition 300 that includes PUs 302-1, 302-2, 302-3, and 302-4. The PUs are used for spatial or temporal predictive coding of CU partition 300. For instance, if CU partition 300 is coded in “intra” mode, each PU 302-1, 302-2, 302-3, and 302-4 has its own prediction direction for spatial prediction. If CU partition 300 is coded in “inter” mode, each PU 302-1, 302-2, 302-3, and 302-4 has its own motion vector(s) and associated reference picture(s) for temporal prediction.

Further, each CU partition of PUs is associated with a set of transform units (TUs). Like other video coding standards, HEVC applies a block transform on residual data to decorrelate the pixels within a block and compact the block energy into low order transform coefficients. However, unlike other standards that apply a single 4×4 or 8×8 transform to a macroblock, HEVC can apply a set of block transforms of different sizes to a single CU. The set of block transforms to be applied to a CU is represented by its associated TUs. By way of example, FIG. 4 illustrates CU partition 300 of FIG. 3 (including PUs 302-1, 302-2, 302-3, and 302-4) with an associated set of TUs 402-1, 402-2, 402-3, 402-4, 402-5, 402-6, and 402-7. These TUs indicate that seven separate block transforms should be applied to CU partition 300, where the scope of each block transform is defined by the location and size of each TU. The configuration of TUs associated with a particular CU can differ based on various criteria.

Once a block transform operation has been applied with respect to a particular TU, the resulting transform coefficients are quantized to reduce the size of the coefficient data. The quantized transform coefficients are then entropy coded, resulting in a final set of compression bits. HEVC currently offers an entropy coding scheme known as context-based adaptive binary arithmetic coding (CABAC). CABAC can provide efficient compression due to its ability to adaptively select context models (i.e., probability models) for arithmetically coding input symbols based on previously-coded symbol statistics. However, the context model selection process in CABAC (referred to as context modeling) is complex and requires significantly more processing power for encoding/decoding than other compression schemes.

### SUMMARY

In one embodiment, a method for encoding video data is provided that includes receiving a transform unit comprising a two-dimensional array of transform coefficients and processing the transform coefficients of the two-dimensional array along a single-level scan order. The processing includes selecting, for each non-zero transform coefficient along the single-level scan order, one or more context models for encoding an absolute level of the non-zero transform coefficient, where the selecting is based on one or more transform coefficients previously encoded along the single-level scan order.

In another embodiment, a method for decoding video data is provided that includes receiving a bitstream of compressed data, the compressed data corresponding to a two-dimensional array of transform coefficients that were previously encoded along a single-level scan order, and decoding the bitstream of compressed data. The decoding includes selecting, for each non-zero transform coefficient along the single-level scan order, one or more context models for decoding an absolute level of the non-zero transform coefficient, where the selecting is based on one or more transform coefficients previously decoded along the single-level scan order.

In another embodiment, a method for encoding video data is provided that includes receiving a transform unit comprising a plurality of transform coefficients, and encoding a significance map of the transform unit and absolute levels of the plurality of transform coefficients using a single scan type and a single context model selection scheme.

In another embodiment, a method for decoding video data is provided that includes receiving a bitstream of compressed data, the compressed data corresponding to a transform unit comprising a plurality of transform coefficients that were previously encoded. The method further comprises decoding a significance map of the transform unit and absolute levels of the plurality of transform coefficients using a single scan type and a single context model selection scheme.

The following detailed description and accompanying drawings provide a better understanding of the nature and advantages of particular embodiments.

### BRIEF DESCRIPTION OF THE DRAWINGS

FIG. 1 illustrates an input picture partitioned into largest coding units (LCUs).

FIG. 2 illustrates an LCU partitioned into coding units (CUs).

FIG. 3 illustrates a CU partitioned into prediction units (PUs).

FIG. 4 illustrates a CU partitioned into PUs and a set of transform units (TU) associated with the CU.

FIG. 5 illustrates an encoder for encoding video content.

FIG. 6 illustrates a decoder for decoding video content.

FIG. 7 illustrates a CABAC encoding/decoding process.

FIG. 8 illustrates a last significant coefficient position in a TU.

FIG. 9 illustrates example neighbors for context model selection using a forward scan.

FIG. 10 illustrates a two-level scanning sequence including a forward zigzag scan per 4×4 sub-block and a reverse zigzag scan within each sub-block.

FIG. 11 illustrates a process for CABAC encoding/decoding of transform coefficient levels using a two-level scanning sequence.

FIG. 12 illustrates a process for CABAC encoding/decoding of transform coefficient levels using a single-level scan according to one embodiment.

FIG. 13 illustrates a single-level, reverse zigzag scan.

FIG. 14 illustrates a single-level, reverse wavefront scan.

FIG. 15 illustrates a process for CABAC encoding/decoding of significance map values and transform coefficient levels using a unified scan type and context model selection scheme according to one embodiment.

FIG. 16 illustrates example neighbors for context model selection using a reverse scan.

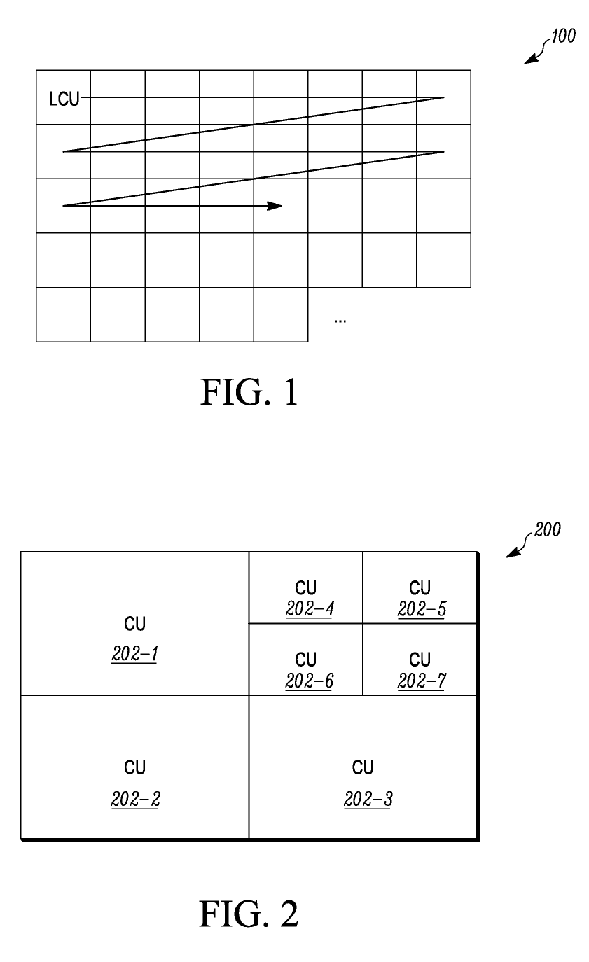

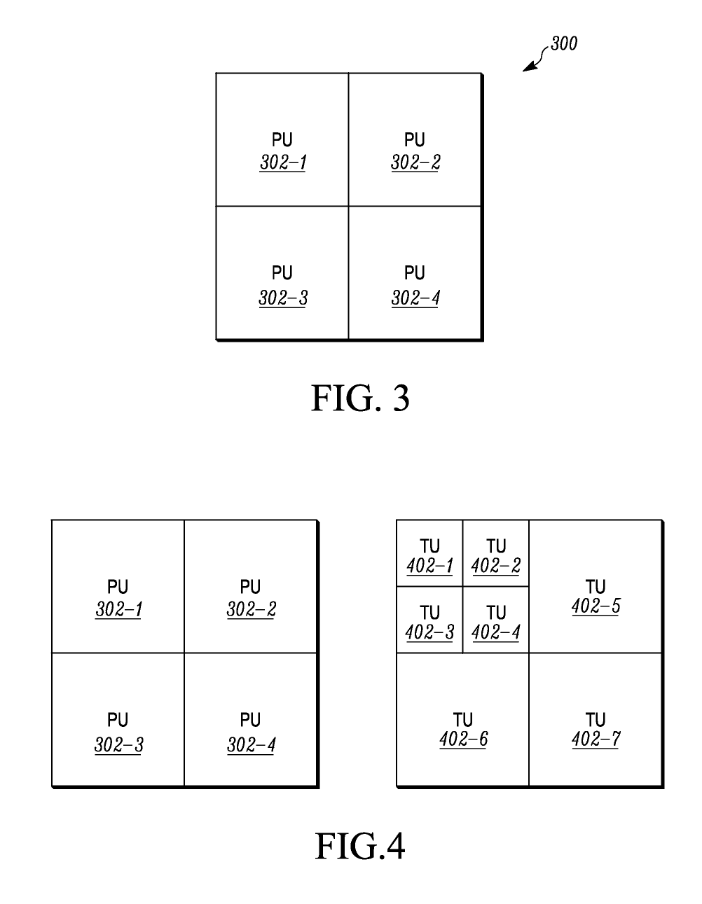

### DETAILED DESCRIPTION

Described herein are context modeling techniques that can be used for transform coefficient level coding within a context-adaptive entropy coding scheme such as CABAC. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

### Encoder and Decoder Embodiments

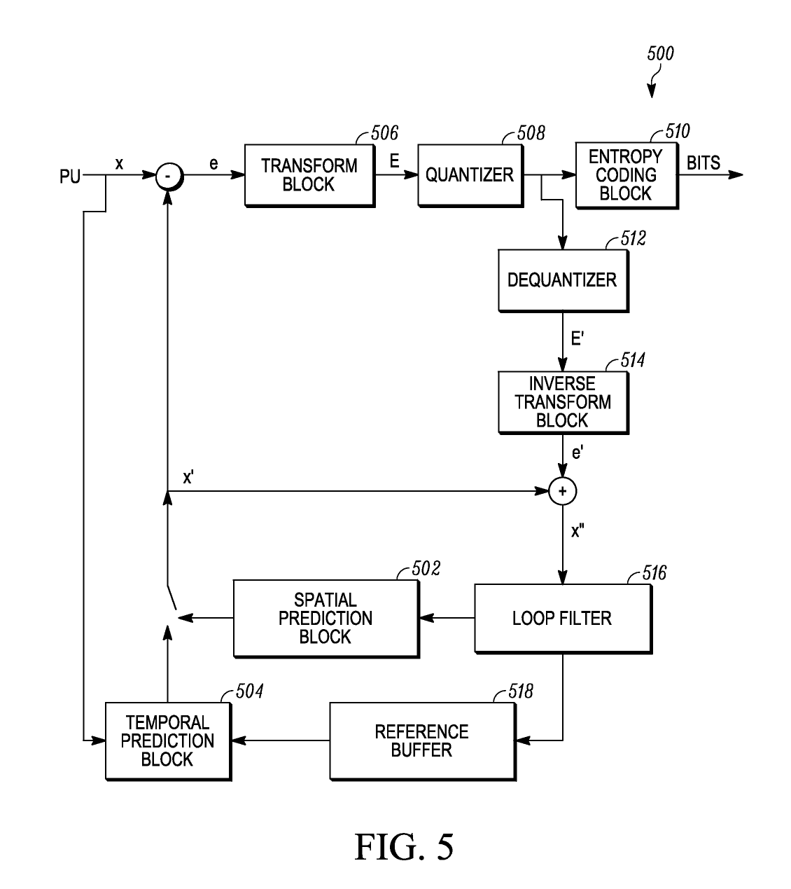

FIG. 5 depicts an example encoder 500 for encoding video content. In one embodiment, encoder 500 can implement the HEVC standard. A general operation of encoder 500 is described below; however, it should be appreciated that this description is provided for illustration purposes only and is not intended to limit the disclosure and teachings herein. One of ordinary skill in the art will recognize various modifications, variations, and alternatives for the structure and operation of encoder 500.

As shown, encoder 500 receives as input a current PU “x.” PU x corresponds to a CU (or a portion thereof), which is in turn a partition of an input picture (e.g., video frame) that is being encoded. Given PU x, a prediction PU “x′” is obtained through either spatial prediction or temporal prediction (via spatial prediction block 502 or temporal prediction block 504). PU x′ is then subtracted from PU x to generate a residual PU “e.”

Once generated, residual PU e is passed to a transform block 506, which is configured to perform one or more transform operations on PU e. Examples of such transform operations include the discrete sine transform (DST), the discrete cosine transform (DCT), and variants thereof (e.g., DCT-I, DCT-II, DCT-III, etc.). Transform block 506 then outputs residual PU e in a transform domain (“E”), such that transformed PU E comprises a two-dimensional array of transform coefficients. In this block, a transform operation can be performed with respect to each TU that has been associated with the CU corresponding to PU e (as described with respect to FIG. 4 above).

Transformed PU E is passed to a quantizer 508, which is configured to convert, or quantize, the relatively high precision transform coefficients of PU E into a finite number of possible values. After quantization, transformed PU E is entropy coded via entropy coding block 510. This entropy coding process compresses the quantized transform coefficients into final compression bits that are subsequently transmitted to an appropriate receiver/decoder. Entropy coding block 510 can use various different types of entropy coding schemes, such as CABAC. A particular embodiment of entropy coding block 510 that implements CABAC is described in further detail below.

In addition to the foregoing steps, encoder 500 includes a decoding process in which a dequantizer 512 dequantizes the quantized transform coefficients of PU E into a dequantized PU “E′.” PU E′ is passed to an inverse transform block 514, which is configured to inverse transform the de-quantized transform coefficients of PU E′ and thereby generate a reconstructed residual PU “e′.” Reconstructed residual PU e′ is then added to the original prediction PU x′ to form a new, reconstructed PU “x″.” A loop filter 516 performs various operations on reconstructed PU x″ to smooth block boundaries and minimize coding distortion between the reconstructed pixels and original pixels. Reconstructed PU x″ is then used as a prediction PU for encoding future frames of the video content. For example, if reconstructed PU x″ is part of a reference frame, reconstructed PU x″ can be stored in a reference buffer 518 for future temporal prediction.

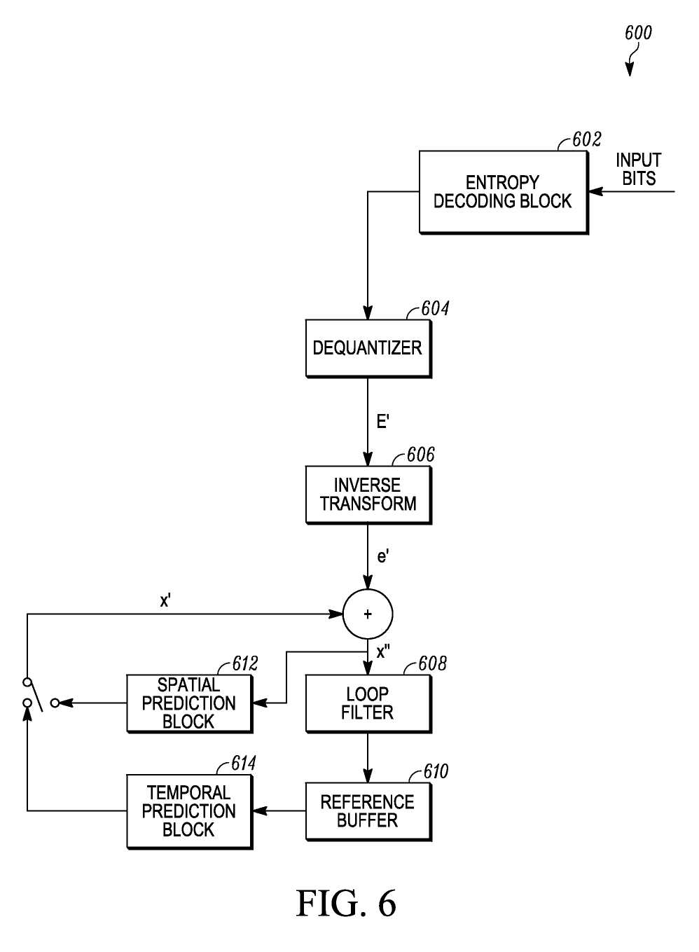

FIG. 6 depicts an example decoder 600 that is complementary to encoder 500 of FIG. 5. Like encoder 500, in one embodiment, decoder 600 can implement the HEVC standard. A general operation of decoder 600 is described below; however, it should be appreciated that this description is provided for illustration purposes only and is not intended to limit the disclosure and teachings herein. One of ordinary skill in the art will recognize various modifications, variations, and alternatives for the structure and operation of decoder 600.

As shown, decoder 600 receives as input a bitstream of compressed data, such as the bitstream output by encoder 500. The input bitstream is passed to an entropy decoding block 602, which is configured to perform entropy decoding on the bitstream to generate quantized transform coefficients of a residual PU. In one embodiment, entropy decoding block 602 is configured to perform the inverse of the operations performed by entropy coding block 510 of encoder 500. Entropy decoding block 602 can use various different types of entropy coding schemes, such as CABAC. A particular embodiment of entropy decoding block 602 that implements CABAC is described in further detail below.

Once generated, the quantized transform coefficients are dequantized by dequantizer 604 to generate a residual PU “E′.” PU E′ is passed to an inverse transform block 606, which is configured to inverse transform the dequantized transform coefficients of PU E′ and thereby output a reconstructed residual PU “e′.” Reconstructed residual PU e′ is then added to a previously decoded prediction PU x′ to form a new, reconstructed PU “x″.” A loop filter 608 perform various operations on reconstructed PU x″ to smooth block boundaries and minimize coding distortion between the reconstructed pixels and original pixels. Reconstructed PU x″ is then used to output a reconstructed video frame. In certain embodiments, if reconstructed PU x″ is part of a reference frame, reconstructed PU x″ can be stored in a reference buffer 610 for reconstruction of future PUs (via, e.g., spatial prediction block 612 or temporal prediction block 614).

### CABAC Encoding/Decoding

As noted with respect to FIGS. 5 and 6, entropy coding block 510 and entropy decoding block 602 can each implement CABAC, which is an arithmetic coding scheme that maps input symbols to a non-integer length (e.g., fractional) codeword. The efficiency of arithmetic coding depends to a significant extent on the determination of accurate probabilities for the input symbols. Thus, to improve coding efficiency, CABAC uses a context-adaptive technique in which different context models (i.e., probability models) are selected and applied for different syntax elements. Further, these context models can be updated during encoding/decoding.

Generally speaking, the process of encoding a syntax element using CABAC includes three elementary steps: (1) binarization, (2) context modeling, and (3) binary arithmetic coding. In the binarization step, the syntax element is converted into a binary sequence or bin string (if it is not already binary valued). In the context modeling step, a context model is selected (from a list of available models per the CABAC standard) for one or more bins (i.e., bits) of the bin string. The context model selection process can differ based on the particular syntax element being encoded, as well as the statistics of recently encoded elements. In the arithmetic coding step, each bin is encoded (via an arithmetic coder) based on the selected context model. The process of decoding a syntax element using CABAC corresponds to the inverse of these steps.

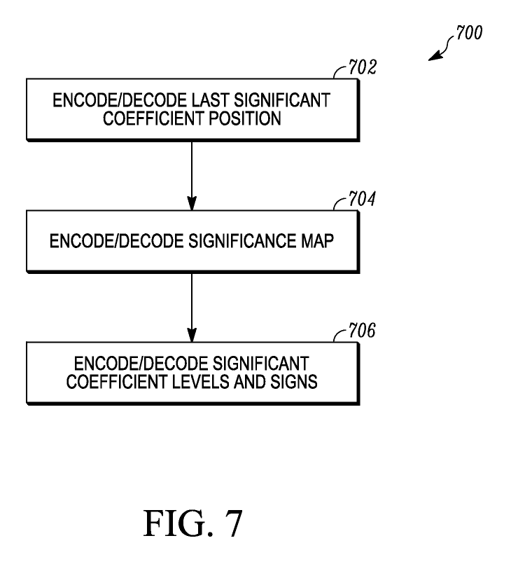

FIG. 7 depicts an exemplary CABAC encoding/decoding process 700 that is performed for encoding/decoding quantized transform coefficients of a residual PU (e.g., quantized PU E of FIG. 5). Process 700 can be performed by, e.g., entropy coding block 510 of FIG. 5 or entropy decoding block 602 of FIG. 6. In a particular embodiment, process 700 is applied to each TU associated with the residual PU.

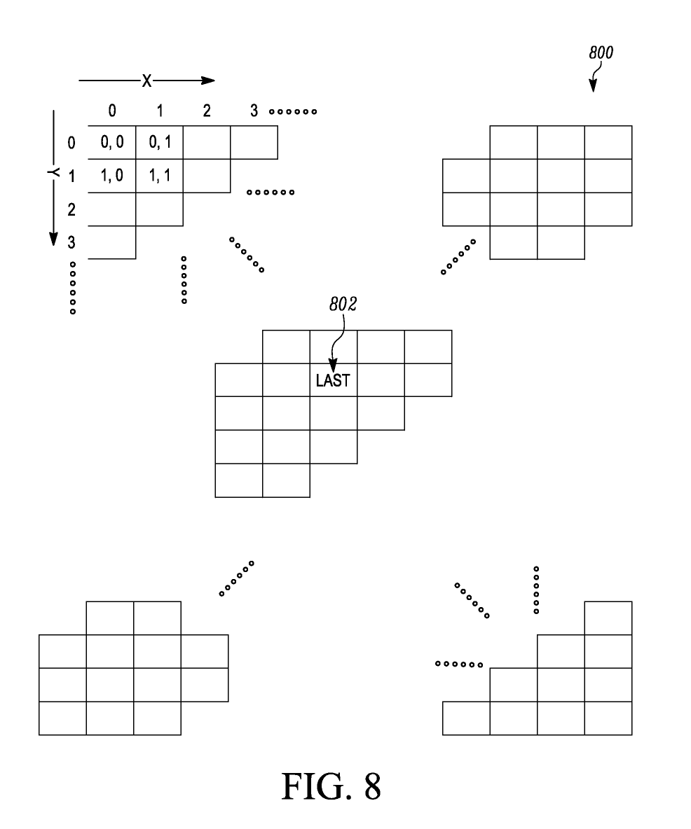

At block 702, entropy coding block 510/entropy decoding block 602 encodes or decodes a last significant coefficient position that corresponds to the (y, x) coordinates of the last significant (i.e., non-zero) transform coefficient in the current TU (for a given scanning pattern). By way of example, FIG. 8 illustrates a TU 800 of N×N transform coefficients, where coefficient 802 corresponds to the last significant coefficient position in TU 800 for, e.g., a zigzag scan. With respect to the encoding process, block 702 includes binarizing a “last_significant_coeff_y” syntax element (corresponding to the y coordinate) and binarizing a “last_significant_coeff_x” syntax element (corresponding to the x coordinate). Block 702 further includes selecting a context model for the last_significant_coeff_y and last_significant_coeff_x syntax elements, where the context model is selected based on a predefined context index (lastCtx) and a context index increment (lastIndInc). In one embodiment, the context index increment is determined as follows:
1. If current TU size is 4×4 pixels, lastIndInc=lastCtx
2. If current TU size is 8×8 pixels, lastIndInc=lastCtx+3
3. If current TU size is 16×16 pixels, lastIndInc=lastCtx+8
4. If current TU size is 32×32 pixels, lastIndInc=lastCtx+15

Once a context model is selected, the last_significant_coeff_y and last_significant_coeff_x syntax elements are arithmetically encoded/decoded using the selected model.

At block 704, entropy coding block 510/entropy decoding block 602 encodes or decodes a binary significance map associated with the current TU, where each element of the significance map (represented by the syntax element significant_coeff_flag) is a binary value that indicates whether the transform coefficient at the corresponding location in the TU is non-zero or not. Block 704 includes scanning the current TU and selecting, for each transform coefficient in scanning order, a context model for the transform coefficient. The selected context model is then used to arithmetically encode/decode the significant_coeff_flag syntax element associated with the transform coefficient. The selection of the context model is based on a base context index (sigCtx) and a context index increment (sigIndInc). Variables sigCtx and sigIndInc are determined dynamically for each transform coefficient using a neighbor-based scheme that takes into account the transform coefficient's position, as well as the significance map values for one or more neighbor coefficients around the current transform coefficient.

In one embodiment, sigCtx and sigIndInc are determined for a given transform coefficient (y, x) as noted below. In this embodiment, it is assumed that the TU is scanned using a forward zigzag scan. Other types of scans may result in the use of different neighbors for determining sigCtx and sigIndInc.
1. If current TU size is 4×4 pixels, sigCtx=y*4+x and sigIndInc=sigCtx+48
2. If current TU size is 8×8 pixels, sigCtx=(y>>1)*4+(x>>1) and sigIndInc=sigCtx+32
3. If current TU size is 16×16 or 32×32 pixels, sigCtx is determined based on the current transform coefficient's position (y, x) and the significance map value of the coefficient's coded neighbors as follows:
   a. If y<=2 and x<=2, sigCtx=y*2+x
   b. Else if y=0 (i.e., the current transform coefficient is at the top boundary of the TU), sigCtx=4+significant_coeff_flag[y][x−1]+significant_coeff_flag[y][x−2]
   c. Else if x=0 (i.e., the current transform coefficient is at the left boundary of the TU), sigCtx=7+significant_coeff_flag[y−1][x]+significant_coeff_flag[y−2][x]
   d. Else if x>1 and y>1, sigCtx=significant_coeff_flag[y−1][x]+significant_coeff_flag[y][x−1]+significant_coeff_flag[y−1][x−1]+significant_coeff_flag[y][x−2]+significant_coeff_flag[y−2][x]
   e. Else if x>1, sigCtx=significant_coeff_flag[y−1][x]+significant_coeff_flag[y][x−1]+significant_coeff flag[y−1][x−1]+significant_coeff_flag[y][x−2]
   f. Else if y>1, sigCtx=significant_coeff_flag[y−1][x]+significant_coeff_flag[y][x−1]+significant_coeff_flag[y−1][x−1]+significant_coeff_flag[y−2][x]
   g. Else sigCtx=significant_coeff_flag[y−1][x]+significant_coeff_flag[y][x−1]+significant_coeff_flag[y−1][x−1]
   h. The final value if sigCtx is 10+min(4, sigCtx)
   4. If current TU size is 16×16, sigIndInc=sigCtx+16
   5. If current TU size is 32×32, sigIndInc=sigCtx

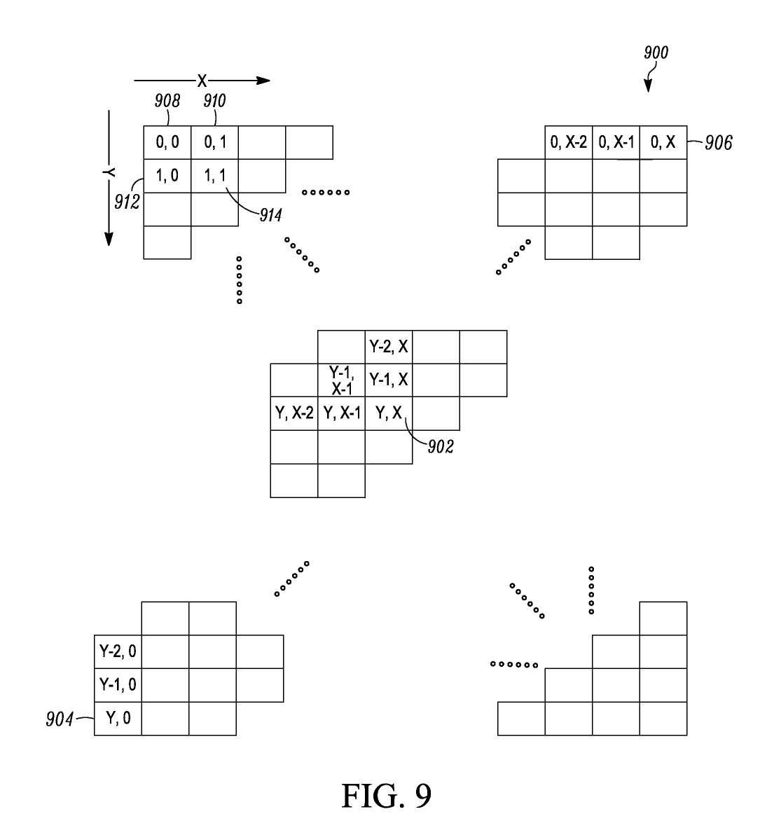

To help visualize the neighbor determination logic above, FIG. 9 illustrates the possible neighbor definitions for different transform coefficients in an example TU 900. For transform coefficients located in the middle of TU 900 (e.g., coefficient 902 located at (y, x)), sigCtx is determined based on the significance map values of five neighbors located at (y, x−1), (y, x−2), (y−1, x), (y−2, x), and (y−1, x−1). For transform coefficients located on the left boundary of TU 900 (e.g., coefficient 904 located at (y, 0)), sigCtx is determined based on the significance map values of two neighbors located at (y−1, 0) and (y−2, 0). For transform coefficients located on the top boundary of TU 900 (e.g., coefficient 906 located at (0, x)), sigCtx is determined based on the significance map values of two neighbors located at (0, x−1) and (0, x−2). And for certain transform coefficients located in the upper top-left boundary of TU 900 (e.g., coefficients 908, 910, 912, 914), sigCtx is not based on any neighbor data.

At block 706 of FIG. 7, entropy coding block 510/entropy decoding block 602 encodes or decodes the significant (i.e., non-zero) transform coefficients of the current TU. This process includes, for each significant transform coefficient, encoding or decoding (1) the absolute level of the transform coefficient (also referred to as the “transform coefficient level”), and (2) the sign of the transform coefficient (positive or negative). As part of encoding/decoding a transform coefficient level, entropy coding block 510/entropy decoding block 602 encodes or decodes three distinct syntax elements: coeff_abs_level_greater1_flag, coeff_abs_level_greater2_flag, and coeff_abs_level_remaining. Coeff_abs_level_greater1_flag is a binary value indicating whether the absolute level of the transform coefficient is greater than 1. Coeff_abs_level_greater2_flag is a binary value indicating whether the absolute level of the transform coefficient is greater than 2. And coeff_abs_level_remaining is a value equal to the absolute level of the transform coefficient minus a predetermined value (in one embodiment, this predetermined value is 3).

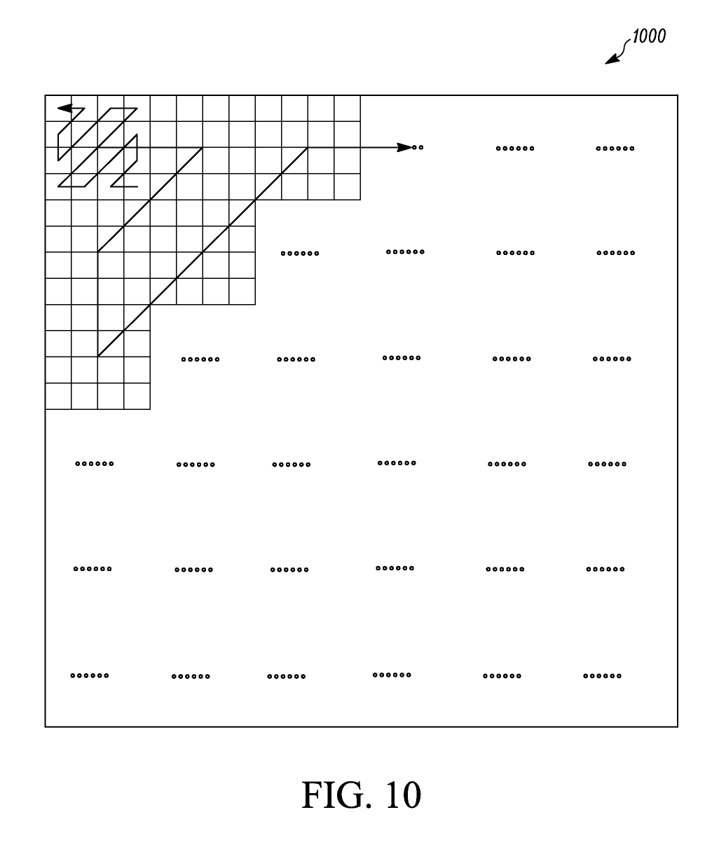

In one embodiment, the process of encoding/decoding the coeff_abs_level_greater1_flag and coeff_abs_level_greater2_flag syntax elements involves selecting a context model for each syntax element based on a sub-block scheme (note that the coeff_abs_level_remaining syntax element does not require context model selection). In this scheme, the current TU is divided into a number of 4×4 sub-blocks, and context model selection for coeff_abs_level_greater1_flag and coeff_abs_level_greater2_flag for a given non-zero transform coefficient is carried out based on statistics within the transform coefficient's sub-block, as well as statistics of previous sub-blocks in the TU. To facilitate this, in block 706, the current TU is scanned using two scans or loops—(1) an outer scan at the sub-block level and (2) an inner scan at the transform coefficient level (within a particular sub-block). This is shown visually in FIG. 10, which depicts a two-level scanning sequence for a TU 1000. In this example, the scanning sequence proceeds according to a forward zigzag pattern with respect to the 4×4 sub-blocks of TU 1000 (i.e., the outer scan). Within each 4×4 sub-block, the scanning sequence proceeds according to a reverse zigzag pattern with respect to the transform coefficients of the sub-block (i.e., the inner scan). This allows each 4×4 sub-block of TU 1000 to be processed in its entirety before moving on to the next sub-block.

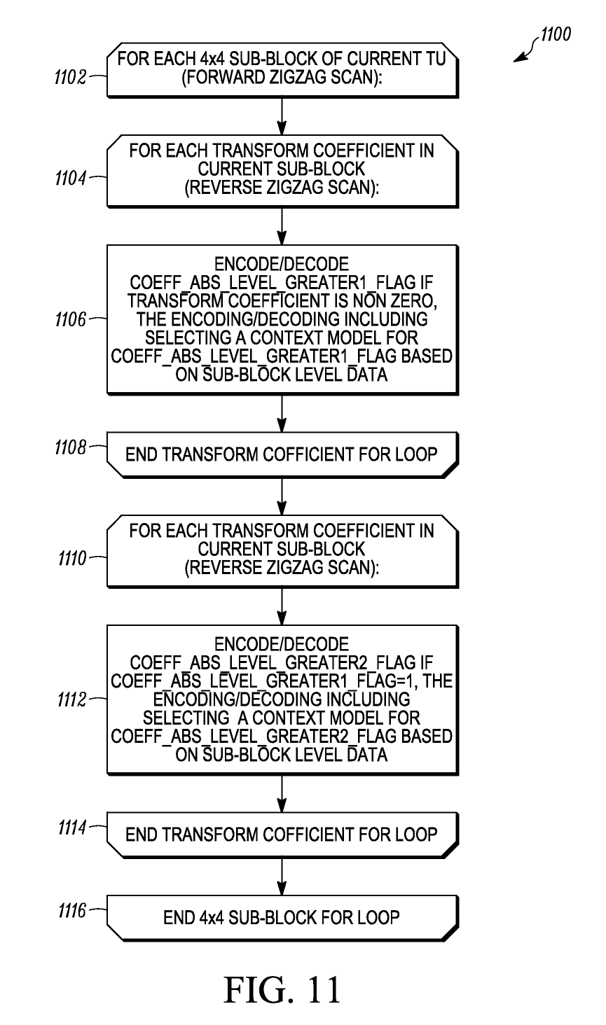

FIG. 11 depicts a process 1100 that illustrates how the coeff_abs_level_greater1_flag and coeff_abs_level_greater2_flag syntax elements are encoded/decoded using the two-level scanning sequence shown in FIG. 10. At block 1102, an outer FOR loop is entered for each 4×4 sub-block of the current TU. This outer FOR loop proceeds according to a first scanning pattern, such as the sub-block-level forward zigzag pattern shown in FIG. 10. At block 1104, an inner FOR loop is entered for each transform coefficient in the current 4×4 sub-block. This inner FOR loop proceeds according to a second scanning pattern, such as the coefficient-level reverse zigzag pattern shown in FIG. 10. Within the inner FOR loop of block 1104, entropy coding block 510/entropy decoding block 602 encodes or decodes the coeff_abs_level_greater1_flag syntax element for the current transform coefficient if the transform coefficient is non-zero (i.e., if the significant_coeff_flag for the transform coefficient in the corresponding significance map is equal to 1) (block 1106).

As noted above, encoding/decoding the coeff_abs_level_greater1_flag syntax element at block 1106 includes selecting an appropriate context model, where the selected context model is based on sub-block level data (e.g., statistics within the current sub-block and statistics of previous sub-blocks in the TU). In one embodiment, selecting the context model for coeff_abs_level_greater1_flag at block 1106 includes first determining a context set (ctxSet) for the current sub-block as follows:
1. If current TU size is 4×4 pixels, ctxSet=0
2. If current TU size is larger than 4×4 and the current 4×4 sub-block is the first in the sub-block-level scanning order (i.e., FOR loop of block 1102), ctxSet=5
3. Else ctxSet is determined by the number transform coefficients that have an absolute value greater than 1 in the previous 4×4 sub-block (lastGreater2Ctx); i.e., ctxSet=((lastGreater2Ctx)>>2)+1

Within each context set, there can be five different context models (numbered 0 to 4). Once a context set for the current sub-block is determined as above, a particular context model within the context set is selected for the coeff_abs_level_greater1_flag syntax element of the current transform coefficient as follows:
1. Initial context is set to 1
2. After a transform coefficient with absolute level greater than 1 in the current 4×4 sub-block has been encoded/decoded, the context model is set to 0
3. When only one transform coefficient in the current 4×4 sub-block has been encoded/decoded and its absolute level is equal to 1, the context model is set to 2
4. When only two transform coefficients in the current 4×4 sub-block have been encoded/decoded and their absolute levels are equal to 1, the context model is set to 3
5. When three or more transform coefficients in the current 4×4 sub-block have been encoded/decoded and their absolute levels are equal to 1, the context model is set to 4

At block 1108, the inner FOR loop initiated at block 1104 ends (once all transform coefficients in the current sub-block are traversed).

At block 1110, another inner FOR loop is entered for each transform coefficient in the current 4×4 sub-block. This loop is substantially similar to loop 1104, but is used to encode/decode the coeff_abs_level_greater2_flag syntax element. In particular, within the inner FOR loop of block 1110, entropy coding block 510/entropy decoding block 602 encodes or decodes coeff_abs_level_greater2_flag for the current transform coefficient if coeff_abs_level_greater1_flag for the transform coefficient is equal to 1 (block 1112).

Like the coeff_abs_level_greater1_flag syntax element, encoding/decoding the coeff_abs_level_greater1_flag syntax element at block 1112 includes selecting an appropriate context model, where the selected context model is based on sub-block level data. In one embodiment, selecting the context model for coeff_abs_level_greater2_flag at block 1112 includes first determining a context set for the current sub-block according to a rule set that is identical to the ctxSet selection rule set described with respect to block 1106. Once a context set for the current sub-block is determined, a particular context model within the context set is selected for the coeff_abs_level_greater2_flag syntax element of the current transform coefficient as follows:
1. Initial context is set to 0
2. When only one transform coefficient with absolute level greater than 1 in the current 4×4 sub-block has been encoded/decoded, the context model is set to 1
3. When only two transform coefficients with absolute level greater than 1 in the current 4×4 sub-block has been encoded/decoded, the context model is set to 3
4. When only three transform coefficients with absolute level greater than 1 in the current 4×4 sub-block has been encoded/decoded, the context model is set to 3
5. When four or more transform coefficients with absolute level greater than 1 in the current 4×4 sub-block has been encoded/decoded, the context model is set to 4

At block 1114, the inner FOR loop initiated at block 1110 ends (once all transform coefficients in the current sub-block are traversed).

Although not shown in FIG. 11, after block 1114, process 1100 can include two additional inner FOR loops (i.e., loops within the current sub-block) for encoding/decoding the coefficient sign and the coeff_abs_level_remaining syntax elements respectively. Note that the coding of these syntax elements does not require any context model selection.

At block 1116, the outer FOR loop initiated at block 1102 ends (once all sub-blocks in the current TU are traversed).

As can be seen from FIG. 11 and its accompanying description, the process of encoding and decoding transform coefficient levels using CABAC can be complex, due in large part to dependencies between 4×4 sub-blocks when selecting context models for the coeff_abs_level_greater1_flag and coeff_abs_level_greater2_flag syntax elements. These sub-block dependencies result in a two-level scanning process and relatively complicated context model selection rules. The following sections describe various enhancements that simplify scanning and context model selection when encoding/decoding transform coefficient levels using CABAC.

### CABAC Encoding/Decoding of Transform Coefficient Levels Using Single-Level Scan

In one set of embodiments, the encoding/decoding of transform coefficient levels at block 706 of FIG. 7 can be modified such that context model selection for the coeff_abs_level_greater1_flag and coeff_abs_level_greater2_flag syntax elements is no longer dependent on sub-block level data. Instead, in these embodiments, the context models can be selected based on individual transform coefficients within the current TU. Thus, in contrast to process 1100 of FIG. 11, there is no need to perform a two-level scanning sequence (i.e., an outer sub-block-level scan and an inner coefficient-level scan per sub-block) to encode/decode transform coefficient levels. Rather, the encoding/decoding can be carried out using a single-level scan (i.e., along a single-level scan order) of the entire TU. This can improve encoding/decoding performance, while simplifying the code needed for context model selection.

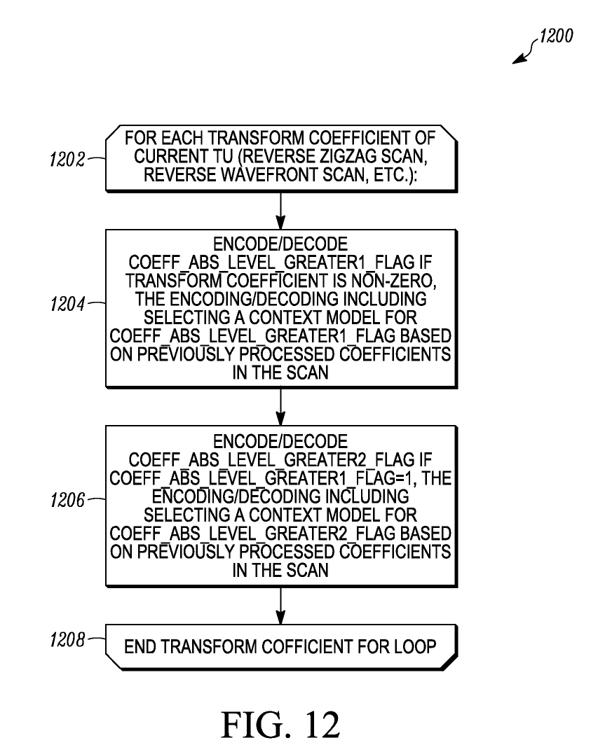

FIG. 12 depicts a process 1200 for carrying out transform coefficient level encoding/decoding in CABAC using a single-level scan according to one embodiment. In particular, FIG. 12 focuses on the encoding/decoding of the coeff_abs_level_greater1_flag and coeff_abs_level_greater2_flag syntax elements (encoding/decoding of the coeff_abs_level_remaining syntax element is not described since that does not require context model selection). Process 1200 can be executed by entropy coding block 510 or entropy decoding block 602 within block 706 of FIG. 7. In one embodiment, process 1200 can be executed in lieu of process 1100 of FIG. 11.

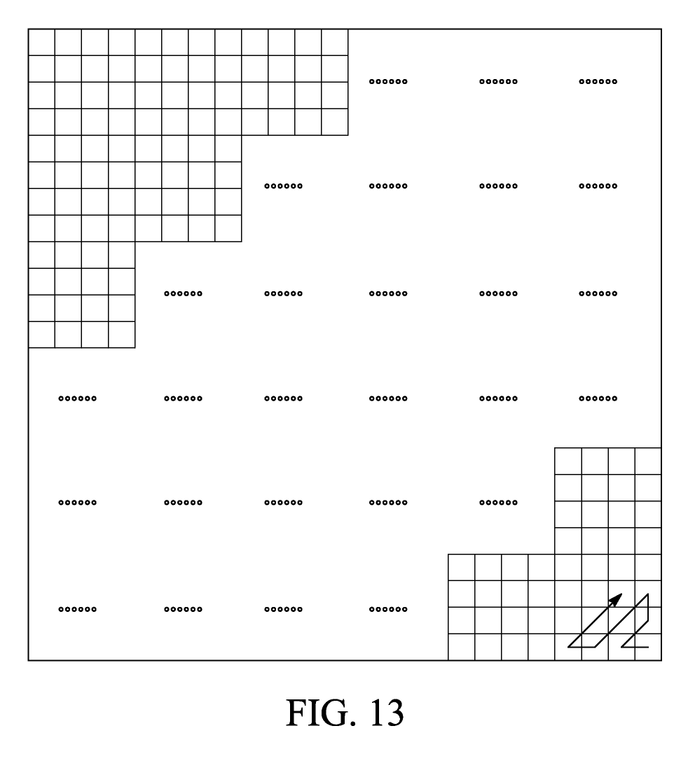

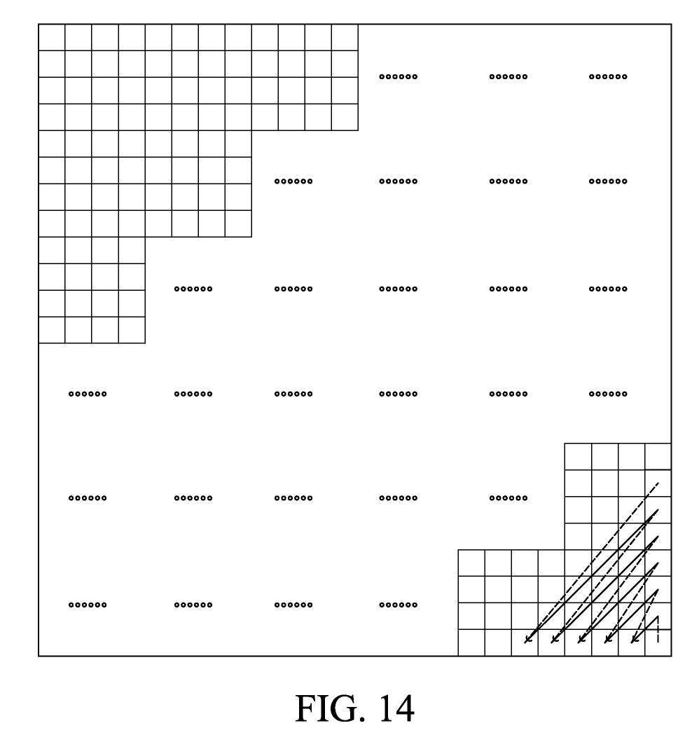

At block 1202, entropy coding block 510/entropy decoding block 602 can enter a FOR loop for each transform coefficient in the current TU. This FOR loop can represent a traversal of the TU along a single-level scan order (i.e., a scan that does not require any sub-block division). In one embodiment, the single-level scan order can correspond to a reverse zigzag scan as shown in FIG. 13. In another embodiment, the single-level scan order can correspond to a reverse wavefront scan as shown in FIG. 14. In a wavefront or reverse wavefront scan, all of the scan lines have the same diagonal scan direction. In yet other embodiments, the single-level scan order can correspond to any other type of scanning pattern known in the art.

At block 1204, entropy coding block 510/entropy decoding block 602 can encode/decode the coeff_abs_level_greater1_flag syntax element for the current transform coefficient if the coefficient is non-zero, where the encoding/decoding includes selecting a context model for coeff_abs_level_greater1_flag based on previously encoded/decoded transform coefficients in the current single-level scan order (i.e., in the FOR loop of block 1202). In one embodiment, selecting this context model can comprise:
1. For all TU sizes:
   a. Set initial context model to 1
   b. If a transform coefficient with absolute level larger than 1 has been previously encoded/decoded in the current single-level scan order, set the context model to 0
   c. If only (n−1) transform coefficient(s) have been previously encoded/decoded in the current single-level scan order and their absolute levels equal 1, set the context model to n ranging from 2 to T−1
   d. If (T−1) transform coefficient(s) have been previously encoded/decoded in the current single-level scan order and their absolute levels equal 1, set the context model to T

Note that in the foregoing logic, context model selection is independent of the size of the current TU because the same rules apply to all TU sizes. Further, with respect to (1)(c) and (1)(d), the selected context model can change based the number of transform coefficients with absolute levels equal to 1 that have been previously encoded/decoded in the current single-level scan order, up to a threshold number T minus 1. When T minus 1 is reached, the context model can be set to the threshold number T. In a particular embodiment, the value of T can be set to 10.

In an alternative embodiment, the foregoing context model selection logic for coeff_abs_level_greater1_flag can be modified to take into account the size of the current TU (ranging from, e.g., 4×4 pixels to 32×32 pixels). In this embodiment, selecting the context model can comprise:
1. For all TU sizes:
   a. Set initial context model to 1
   b. If a transform coefficient with an absolute level greater than 1 has been previously encoded/decoded in the current single-level scan order, set the context model to 0
2. For 4×4 TUs, if only (n_{4×4}−1) transform coefficient(s) have been encoded/decoded in the current 4×4 TU and their absolute level(s) are equal to 1, set the context model to n_{4×4} ranging from 2 to T_{4×4}−1; if (T_{4×}−1) or more transform coefficient(s) have been encoded/decoded in the current 4×4 TU and their levels are equal to 1, set the context model to T_{4×4}
3. For 8×8 TUs, if only (n_{8×8}−1) transform coefficient(s) have been encoded/decoded in the current 8×8 TU and their absolute level(s) are equal to 1, set the context model to n_{8×8} ranging from 2 to T_{8×8}−1; if (T_{8×8}−1) or more transform coefficient(s) have been encoded/decoded in the current 8×8 TU and their levels are equal to 1, set the context model to T_{8×8}
4. For 16×16 TUs, if only (n_{16×16}−1) transform coefficient(s) have been encoded/decoded in the current 16×16 TU and their absolute level(s) are equal to 1, set the context model to n_{16×16} ranging from 2 to T_{16×16}−1; if (T_{16×16}−1) or more transform coefficient(s) have been encoded/decoded in the current 16×16 TU and their levels are equal to 1, set the context model to T_{16×16}
5. For 32×32 TUs, if only (n_{32×32}−1) transform coefficient(s) have been encoded/decoded in the current 32×32 TU and their absolute level(s) are equal to 1, set the context model to n_{32×32} ranging from 2 to T_{32×32}−1; if (T_{32×32}−1) or more transform coefficient(s) have been encoded/decoded in the current 32×32 TU and their levels are equal to 1, set the context model to T_{32×32}

In a particular embodiment, the value of threshold numbers T_{4×4}, T_{8×8}, T_{16×16}, and T_{32×32} above can be set to 4, 6, 8, and 10 respectively.

At block 1206, entropy coding block 510/entropy decoding block 602 can encode/decode the coeff_abs_level_greater2_flag syntax element for the current transform coefficient, where the encoding/decoding includes selecting a context model for coeff_abs_level_greater2_flag based on previously encoded/decoded transform coefficients in the current single-level scan order. In one embodiment, selecting this context model can comprise:
1. For all TU sizes:
   a. Set initial context model to 0
   b. If only m transform coefficient(s) with absolute level(s) greater than 1 have been previously encoded/decoded in the current single-level scan order, set the context model to m ranging from 1 to K−1
   c. If K or more transform coefficient(s) with absolute level(s) greater than 1 have been previously encoded/decoded in the current single-level scan order, set the context model to K

Note that in the foregoing logic, context model selection is independent of the size of the current TU because the same rules apply to all TU sizes. Further, with respect to (1)(b) and (1)(c), the selected context model can change based the number of transform coefficients with absolute levels greater than 1 that have been previously encoded/decoded in the current single-level scan order, up to a threshold number K minus 1. When K is reached, the context model can be set to the threshold number K. In a particular embodiment, the value of K can be set to 10.

In an alternative embodiment, the foregoing context model selection logic for coeff abs_level_greater2_flag can be modified to take into account the size of the current TU (ranging from, e.g., 4×4 pixels to 32×32 pixels). In this embodiment, selecting the context model can comprise:
1. For all TU sizes, set initial context model to 0
2. For 4×4 TUs, if only (m_{4×4}−1) transform coefficient(s) with absolute level(s) greater than 1 have been encoded/decoded in the current 4×4 TU, set the context model to m_{4×4} ranging from 1 to K_{4×4}−1; if K_{4×4} or more transform coefficient(s) with absolute level(s) greater than 1 have been encoded/decoded in the current 4×4 TU, set the context model to K_{4×4}
3. For 8×8 TUs, if only (m_{8×8}−1) transform coefficient(s) with absolute level(s) greater than 1 have been encoded/decoded in the current 8×8 TU, set the context model to m_{8×8} ranging from 1 to K_{8×8}−1; if K_{8×8} or more transform coefficient(s) with absolute level(s) greater than 1 have been encoded/decoded in the current 8×8 TU, set the context model to K_{8×8}
4. For 16×16 TUs, if only (m_{16×16}−1) transform coefficient(s) with absolute level(s) greater than 1 have been encoded/decoded in the current 16×16 TU, set the context model to m_{16×16} ranging from 1 to K_{16×16}−1; if K_{16×16} or more transform coefficient(s) with absolute level(s) greater than 1 have been encoded/decoded in the current 16×16 TU, set the context model to K_{16×16}
5. For 32×32 TUs, if only (m_{32×32}−1) transform coefficient(s) with absolute level(s) greater than 1 have been encoded/decoded in the current 32×32 TU, set the context model to m_{32×32} ranging from 1 to K_{32×32}−1; if K_{32×32} or more transform coefficient(s) with absolute level(s) greater than 1 have been encoded/decoded in the current 4×4 TU, set the context model to K_{32×32}

In a particular embodiment, the value of threshold numbers K_{4×4}, K_{8×8}, K_{16×16}, and K_{32×32} above can be set to 4, 6, 8, and 10 respectively.

At block 1208, the FOR loop initiated at block 1202 can end (once all transform coefficients in the current TU are processed along the single-level scan order).

Although FIG. 12 depicts the encoding/decoding of the coeff_abs_level_greater1_flag and coeff_abs_level_greater2_flag syntax elements as occurring in a single loop (i.e., FOR loop 1202), in certain embodiments these syntax elements can be encoded/decoded in separate loops. In these embodiments, each FOR loop for coeff_abs_level_greater1_flag or coeff_abs_level_greater2_flag can correspond to a single-level scan of the current TU.

### CABAC Encoding/Decoding of Transform Coefficient Levels and Significance Map Using Unified Scan Type and Context Model Selection

As noted above, one aspect of encoding/decoding a TU using CABAC is encoding/decoding a binary significance map that indicates whether each transform coefficient in the TU is non-zero or not. In the current HEVC standard, the method by which context models are selected for encoding/decoding each element of the significance map (i.e., significant_coeff_flag) is significantly different from the method by which context models are selected for encoding/decoding transform coefficient levels. For example, as described with respect to block 704 of FIG. 7, encoding/decoding a significance map for a TU involves traversing the TU using, e.g., a forward zigzag scan, and selecting a context model for the significant_coeff_flag syntax element of each transform coefficient based on the significance map values of certain neighbors surrounding the transform coefficient. In contrast, as described with respect to block 706 of FIG. 7, encoding/decoding transform coefficient levels for a TU involves traversing the TU using a two-level, nested scanning sequence (e.g., an outer forward zigzag scan per 4×4 sub-block and an inner reverse zigzag scan within a given sub-block), and selecting separate context models for the abs_coeff_level_greater1_flag and abs_coeff_level_greater2_flag syntax elements of each transform coefficient based on sub-block level coefficient data.

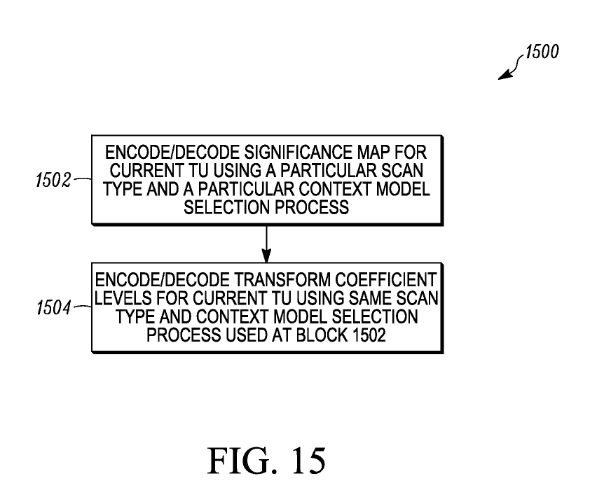

In certain embodiments, the processing performed at blocks 704 and 706 can be modified such that the significance map and the transform coefficient levels for a TU are encoded/decoded using the same scan type and the same context model selection scheme. This approach is shown in FIG. 15 as process 1500.

At block 1502, entropy coding block 510/entropy decoding block 602 can encode or decode a significance map for a current TU using a particular scan type and a particular context model selection scheme. In one set of embodiments, the scan type used at block 1502 can be a single-level forward zigzag scan, a reverse zigzag scan, a forward wavefront scan, a reverse wavefront scan, or any other scan type known in the art. The context model selection scheme used at block 1502 can be a neighbor-based scheme, such as the scheme described above with respect to block 704 of FIG. 7. The neighbor-based scheme can select, for each transform coefficient of the current TU, a context model for the significant_coeff_flag syntax element of the transform coefficient based on one or more neighbor transform coefficients surrounding the transform coefficient. In one embodiment, the logic for controlling neighbor selection in this scheme can vary based upon scan type used (e.g., forward zigzag, reverse zigzag, etc.).

At block 1504, entropy coding block 510/entropy decoding block 602 can encode or decode the absolute level (e.g., the coeff_abs_level_greater1_flag and coeff abs_level_greater2_flag syntax elements) of each transform coefficient in the current TU using the same scan type and context model selection scheme used at block 1502. For example, if a reverse zigzag scan was used for significance map encoding/decoding at block 1502, the same reverse zigzag scan can be used for transform coefficient level encoding/decoding at block 1504. Further, if a specific neighbor-based context model selection scheme was used for significance map encoding/decoding at block 1502, the same (or similar) neighbor-based scheme can be used for transform coefficient level encoding/decoding at block 1504. This unified approach can significantly reduce the complexity of the software and/or hardware needed to implement CABAC encoding and decoding, since a large portion of software and/or hardware logic can be reused for the significance map and the transform coefficient level coding phases.

The following is example logic that can be applied for selecting context models for the significant_coeff_flag, coeff_{—l abs}_level_greater1_flag, and coeff_abs_level_greater2_flag syntax elements of a transform coefficient (y, x) in a TU when a unified forward scan type (e.g., forward zigzag, forward wavefront, etc.) and a unified neighbor-based scheme is used. In various embodiments, the same logic can be applied for each of the three syntax elements. Variable baseCtx refers to the base context index for the syntax element and variable ctxIndInc refers to the context index increment for the syntax element.
1. If current TU size is 4×4 pixels, baseCtx=y*4+x and ctxIndInc=baseCtx+48
2. If current TU size is 8×8 pixels, baseCtx=(y>>1)*4+(x>>1) and ctxIndInc=baseCtx+32
3. If current TU size is 16×16 or 32×32 pixels, baseCtx is determined based on the current transform coefficient's position (y, x) and the significance map value of the coefficient's coded neighbors as follows:
   a. If y<=2 and x<=2, baseCtx=y*2+x
   b. Else if y=0 (i.e., the current transform coefficient is at the top boundary of the TU), baseCtx=4+significant_coeff_flag[y][x−1]+significant_{—} coeff_flag[y][x−2]
   c. Else if x=0 (i.e., the current transform coefficient is at the left boundary of the TU), baseCtx=7+significant_coeff_flag[y−1][x]+significant_coeff_flag[y−2][x]
   d. Else if x>1 and y>1, baseCtx=significant_coeff_flag[y−1][x]+significant_{—} coeff_flag[y][x−1]+significant_{—} coeff_flag[y−1][x−1]+significant_{—} coeff_flag[y][x−2]+significant_coeff_flag[y−2][x]
   e. Else if x>1, baseCtx=significant_coeff_flag[y−1][x]+significant_coeff_flag[y][x−1]+significant_coeff_flag[y−1][x−1]+significant_coeff_flag[y][x−2]
   f. Else if y>1, baseCtx=significant_coeff_flag[y−1][x]+significant_coeff_flag[y][x−1]+significant_coeff_flag[y−1][x−1]+significant_coeff_flag[y−2][x]
   g. Else baseCtx=significant_coeff_flag[y−1][x]+significant_coeff flag[y][x−1]+significant_coeff_flag[y−1][x−1]
   h. The final value if baseCtx is 10+min(4, baseCtx)
4. If current TU size is 16×16, baseIndInc=baseCtx+16
5. If current TU size is 32×32, baseIndInc=baseCtx

The specific neighbors that are used to determine baseCtx in the logic above is visually shown in TU 900 of FIG. 9. For transform coefficients located in the middle of TU 900 (e.g., coefficient 902 located at (y, x)), baseCtx is determined based on the five neighbors located at (y, x−1), (y, x−2), (y−1, x), (y−2, x), and (y−1, x−1). For transform coefficients located on the left boundary of TU 900 (e.g., coefficient 904 located at (y, 0)), baseCtx is determined based on the two neighbors located at (y−1, 0) and (y−2, 0). For transform coefficients located on the top boundary of TU 900 (e.g., coefficient 906 located at (0, x)), baseCtx is determined based on the two neighbors located at (0, x−1) and (0, x−2). And for certain transform coefficients located in the upper top-left boundary of TU 900 (e.g., coefficients 908, 910, 912, 914), baseCtx is not based on any neighbor data.

The following is example logic that can be applied for selecting context models for the significant_coeff_flag, coeff_abs_level_greater1_flag, and coeff_abs_level_greater2_flag syntax elements of a transform coefficient (y, x) in a TU when a unified reverse scan type (e.g., reverse zigzag, reverse wavefront, etc.) and a unified neighbor-based scheme is used. In various embodiments, the same logic can be applied for each of the three syntax elements. Variable baseCtx refers to the base context index for the syntax element and variable ctxlndlnc refers to the context index increment for the syntax element.
1. If current TU size is 4×4 pixels, baseCtx=y*4+x and ctxIndInc=baseCtx+48
2. If current TU size is 8×8 pixels, baseCtx=(y>>1)*4+(x>>1) and ctxIndInc=baseCtx+32
3. If current TU size is 16×16 or 32×32 pixels, baseCtx is determined based on the current transform coefficient's position (y, x) and the significance map value of the coefficient's coded neighbors as follows:
   a. If y<=2 and x<=2, baseCtx=y*2+x
   b. Else if y=0 (i.e., the current transform coefficient is at the top boundary of the TU), baseCtx=4+significant_coeff_flag[y][x+1]+significant_coeff_flag[y][x+2]
   c. Else if x=0 (i.e., the current transform coefficient is at the left boundary of the TU), baseCtx=7+significant_coeff_flag[y+1][x]+significant_coeff_flag[y+2][x]
   d. Else if x>1 and y>1, baseCtx=significant_coeff_flag[y+1][x]+significant_coeff_flag[y][x+1]+significant_coeff_flag[y+1][x+1]+significant_coeff_flag[y][x+2]+significant_coeff_flag[y+2][x]
   e. Else if x>1, baseCtx=significant_coeff_flag[y+1][x]+significant_coeff_flag[y][x+1]+significant_coeff_flag[y+1][x+1]+significant_coeff_flag[y][x+2]
   f. Else if y>1, baseCtx=significant coeff flag[y+1][x]+significant_coeff_flag[y][x+1]+significant_coeff_flag[y+1][x+1]+significant_coeff_flag[y+2][x]
   g. Else baseCtx=significant_coeff_flag[y+1][x]+significant_coeff_flag[y][x+1]+significant_coeff_flag[y+1][x+1]
   h. The final value if baseCtx is10 +min(4, baseCtx)
4. If current TU size is 16×16, baseIndInc=baseCtx+16
5. If current TU size is 32×32, baseIndInc=baseCtx

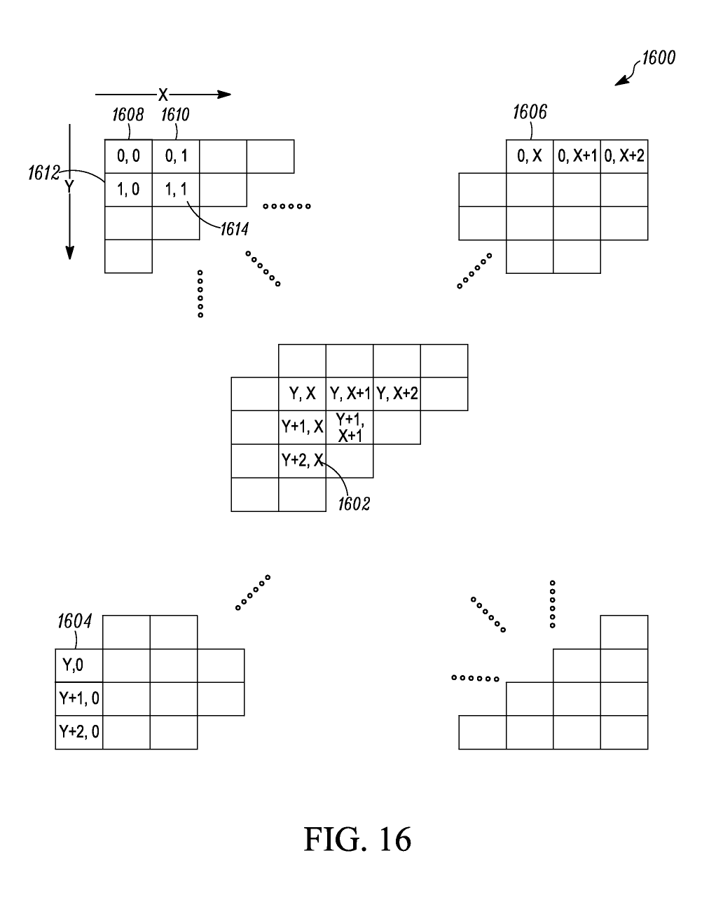

The specific neighbors that are used to determine baseCtx in the logic above is visually shown in TU 1600 of FIG. 16. For transform coefficients located in the middle of TU 1600 (e.g., coefficient 1602 located at (y, x)), baseCtx is determined based on the five neighbors located at (y, x+1), (y, x+2), (y+1, x), (y+2, x), and (y+1, x+1). For transform coefficients located on the left boundary of TU 1600 (e.g., coefficient 1604 located at (y, 0)), baseCtx is determined based on the two neighbors located at (y+1, 0) and (y+2, 0). For transform coefficients located on the top boundary of TU 1600 (e.g., coefficient 1606 located at (0, x)), baseCtx is determined based on the two neighbors located at (0, x+1) and (0, x+2). And for certain transform coefficients located in the upper top-left boundary of TU 1600 (e.g., coefficients 1608, 1610, 1612, 1614), baseCtx is not based on any neighbor data.

Particular embodiments may be implemented in a non-transitory computer-readable storage medium for use by or in connection with an instruction execution system, apparatus, device, or machine. For example, the non-transitory computer-readable storage medium can contain program code or instructions for controlling a computer system/device to perform a method described by particular embodiments. The program code, when executed by one or more processors of the computer system/device, can be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method for encoding video data comprising:
receiving, by a computing device, a transform unit comprising a two-dimensional array of transform coefficients; and
processing, by the computing device, the transform coefficients of the two-dimensional array along a single-level scan order,
wherein the processing comprises, for each non-zero transform coefficient along the single-level scan order, selecting one or more context models for encoding an absolute level of the non-zero transform coefficient, the selecting being based on one or more transform coefficients previously encoded along the single-level scan order.

2. The method of claim 1 wherein selecting the one or more context models comprises selecting a first context model for a first syntax element associated with the non-zero transform coefficient, the first syntax element indicating whether the absolute level for the non-zero transform coefficient is greater than one.

3. The method of claim 2 wherein selecting the first context model is based on a first threshold number of transform coefficients previously encoded along the single-level scan order that have an absolute level equal to one.

4. The method of claim 3 wherein the first threshold number is equal to ten.

5. The method of claim 2 wherein selecting the one or more context models further comprises selecting a second context model for a second syntax element associated with the non-zero transform coefficient, the second syntax element indicating whether the absolute level for the non-zero transform coefficient is greater than two.

6. The method of claim 5 wherein selecting the second context model is based on a second threshold number of transform coefficients previously encoded along the single-level scan order that have an absolute level greater than one.

7. The method of claim 6 wherein the second threshold number is equal to ten.

8. The method of claim 1 wherein selecting the one or more context models is further based on a size of the transform unit.

9. The method of claim 1 wherein the single-level scan order corresponds to a reverse zigzag scan or a reverse wavefront scan.

10. A method for decoding video data comprising:
receiving, by a computing device, a bitstream of compressed data, the compressed data corresponding to a two-dimensional array of transform coefficients that were previously encoded along a single-level scan order; and
decoding, by the computing device, the bitstream of compressed data,
wherein the decoding comprises, for each non-zero transform coefficient along the single-level scan order, selecting one or more context models for decoding an absolute level of the non-zero transform coefficient, the selecting being based one or more transform coefficients previously decoded along the single-level scan order.

11. The method of claim 10 wherein selecting the one or more context models comprises selecting a first context model for a first syntax element associated with the non-zero transform coefficient, the first syntax element indicating whether the absolute level for the transform coefficient is greater than one.

12. The method of claim 11 wherein selecting the first context model is based on a first threshold number of transform coefficients previously decoded along the single-level scan order that have an absolute level equal to one.

13. The method of claim 11 wherein selecting the one or more context models further comprises selecting a second context model for a second syntax element associated with the non-zero transform coefficient, the second syntax element indicating whether the absolute level for the non-zero transform coefficient is greater than two.

14. A method of claim 13 wherein selecting the second context model is based on a second threshold number of transform coefficients previously decoded along the single-level scan order that have an absolute level greater than one.

15. A method for encoding video data comprising:
receiving, by a computing device, a transform unit comprising a plurality of transform coefficients; and
encoding, by the computing device, a significance map of the transform unit and absolute levels of the plurality of transform coefficients using a single scan type and a single context model selection scheme.

16. The method of claim 15 wherein the single scan type is a forward zigzag scan, a reverse zigzag scan, a forward wavefront scan, or a reverse wavefront scan.

17. The method of claim 16 wherein the single context model selection scheme is a neighbor-based scheme that selects, for each transform coefficient in the plurality of transform coefficients, a context model for the transform coefficient based on one or more neighbor transform coefficients previously encoded along the single scan type.

18. A method for decoding video data comprising:
receiving, by a computing device, a bitstream of compressed data, the compressed data corresponding to a transform unit comprising a plurality of transform coefficients that were previously encoded; and
decoding, by the computing device, a significance map of the transform unit and absolute levels of the plurality of transform coefficients using a single scan type and a single context model selection scheme.

19. The method of claim 18 wherein the single scan type is a forward zigzag scan, a reverse zigzag scan, a forward wavefront scan, or a reverse wavefront scan.

20. The method of claim 18 wherein the single context model selection scheme is a neighbor-based scheme that selects, for each transform coefficient in the plurality of transform coefficients, a context model for the transform coefficient based on one or more neighbor transform coefficients previously decoded along the single scan type.
